(19) United States
(12) Patent Application Publication
(10) Pub. No.: US 2006/0167919 A1
(43) Pub. Date: Jul. 27, 2006

(54) Intelligent platform management interface validating system and method

(75) Inventor: Chih-tao Hsieh, Ban-Qiao City (TW)

Correspondence Address: MADSON & AUSTIN;GATEWAY TOWER WEST, SUITE 900, 15 WEST SOUTH TEMPLE, SALT LAKE CITY, UT, 84101, US

(73) Assignee: Aten International Co., Ltd.

(21) Appl. No.: 11/393,160

(22) Filed: Mar. 29, 2006

Related U.S. Application Data
(63) Continuation-in-part of application No. 10/710,524, filed on Jul. 19, 2004.

(51) Int. Cl. G06F 17/00; G06F 7/00

(52) U.S. Cl. 707/101

(57) ABSTRACT

An Intelligent Platform Management Interface (IPMI) validating system used between a host system and an operation terminal is provided. The IPMI validating system includes a validating program library for storing a plurality of validating programs coded in a programming language, a user interface configured in the operation terminal, for providing a plurality of selectable commands to be assigned wherein each of the selectable commands corresponds to one of the validating programs stored in the validating program library, and a validating module disposed at the host system for executing a health test of the host system according to the validating programs corresponding to the assigned selectable commands.

### CROSS REFERENCE TO RELATED APPLICATION

This is a continuation-in-part of a U.S. patent application Ser. No. 10/710,524 filed on Jul. 19, 2004.

### BACKGROUND OF INVENTION

1. Field of the Invention

The present invention relates to an intelligent platform management interface (IPMI) validating system and a method, and more particularly, to an IPMI validating system and method used in server management.

2. Description of the Prior Art

Recently, the overall number of servers is increasing year by year in many companies, especially in multi-nations enterprises. Nevertheless, conventionally, as soon as a remote server, i.e. a server which is not physically located on the acting person's “desk”, is in malfunction, the diagnosis of the remote server is normally accomplished by bringing a skilled person (i.e. an administrator) to the server. That is very inconvenient for management. In order to overcome such defect to easily manage the remote server, the Intelligent Platform Management Interface (IPMI) specification regulated by Intel, NEC, Hewlett-Packard, and Dell corporation provides a standard interface to hardware used for monitoring characteristics of the server, such as temperature, voltage, power supplies and fans. IPMI-enabled servers monitor and store platform information in a common format which can be accessed by server management software. The monitoring and controlling functions of the IPMI are independent of the server's main processor, basic input output system (BIOS), and operating system (OS) through the use of a baseboard management controller (BMC).

The IPMI controls the management software of the system and the interface between the platform and the hardware. Moreover, the IPMI can operate in different firmware and hardware platforms at the same time. The IPMI automatically provides the system status detection of software/hardware of the servers, event diary log, rebooting system control functions, automatic alarm for the event and auto-system control (such as failure of power). For instance, an I²C digital sensor connected to the IPMI can detect real time system voltage, temperature and speed of the fan of the remote server and determine whether the detected data is beyond a predetermined range. In addition, the IPMI makes it convenient for the system manager to remotely. monitor the servers through a local area network (LAN) or a serial modem. When a critical event occurs, the system manager can execute a fault correction procedure immediately. For example, if the temperature of the server is over the predetermined range, the speed of the fan is immediately increased to eliminate heat. If the condition is critical, in addition to recording data for future inquiry, the system manager, who is far from the server, may be informed through the LAN at the same time.

However, IPMI of different manufacturers, including the hardware and firmware, may have different functions. Therefore, an IPMI conformance test suite (ICTS) software is utilized for executing a pass-fail test to determine whether the IPMI is compatible with each hardware/software environment in different servers, such as BIOS, firmware, OS, LAN, bus, and CPU. As shown in FIG. 1, the structure of the pass-fail test system may include an ICTS framework manager, an ICTS utility library, a message routing library, and a set of transport API. The ICTS framework manager generates a GUI command to control a TCL/TK test module to validate the IPMI. The ICTS utility library provides ICTS functions. The message routing library provides IPMI message functions. The transport API is connected to an assigned channel for transmitting an IPMI command.

According to the prior art, as shown in FIG. 1, when a ICTS is required to execute a loaded TCL/TK test module (step S100) to validate the IPMI, the ICTS should be connected to a TCL/TK engine outside the ICTS (step S122), configuration files of each system (step S110), transport modules inside the ICTS (step S134), and each library (step S114 and S132). The TCL/TK engine, the TCL/TK test module, and the ICTS framework manager are written in the TCL/TK language; therefore, the TCL/TK engine first combines the TCL/TK test module with the ICTS framework manager in order to encode into IPMI commands so as to validate the IPMI, as shown in step S120. In addition, a part of the TCL/TK engine and the configuration files not belonging to the ICTS must be loaded into a computer of a user (the validating terminal) before the ICTS is loaded. The transport modules and libraries are first written according to the requirement and then compiled. The procedure is complicated.

Sometimes the scope of the test provided by the ICTS mentioned above is not broad enough such that not the entire IPMI and the hardware/software environment in the servers are included, or a particular test demand of the system manager is not satisfied. Therefore, if the system manager wants to expand or modify the test scope or functions of the ICTS, a test module should be, as shown in step S120, rewritten, transformed with the ICTS framework manager by the TCL/TK engine and executed. Otherwise the libraries provided to each test module, such as the ICTS utility library, must be rewritten in advance.

However, if the system manager wants to write the test module by himself, first they have to know the entire structure of the IPMI and the IPMI commands, and learn the TCL/TK language. However, the TCL/TK commands are not developed according to the ICTS. Thus in practice, it is quite complex using these commands and the efficiency of the program for the IPMI is not adequate. What is worse is that the system manager may not be familiar with the TCL/TK script language, and therefore, the system manager must learn the new language for validating the IPMI. This wastes time and is not likely to be possible in critical situations.

In step S120, the TCL/TK test module must be connected to the ICTS framework manager to be executed. Therefore, if a significant modification is required in the future, the current test module might not meet the needs of the new environment. A new test module should be developed while it is still not convenient to use the TCL/TK commands in the ICTS.

Moreover, the design of the ICTS is also too complicated. For instance, when validating each test modules, the ICTS should be connected to each modules/libraries according to different demands, the TCL/TK engine, the ICTS framework manager, the configuration files, and the libraries. This requires programs of different layers and also reduces the execution efficiency of the ICTS. Furthermore, for a beginner, learning the TCL/TK programming language for programming verification program in order to test or maintain a new IPMI-enabled server is inefficient. Therefore, if a new and better structure of the ICTS could be provided, the execution efficiency of the ICTS will be increased and thus the efficiency of validating the IPMI will be improved.

### SUMMARY OF INVENTION

It is therefore a primary objective of the claimed invention to provide an IPMI validating system and a method to solve the above-mentioned problems.

Briefly summarized, an Intelligent Platform Management Interface (IPMI) validating system used between a host system and an operation terminal is disclosed. The IPMI validating system comprises a validating program library for storing a plurality of validating programs coded in a programming language, a user interface configured in the operation terminal, for providing a plurality of selectable commands to be assigned wherein each of the selectable commands corresponds to one of the validating programs stored in the validating program library, and a validating module disposed at the host system for executing a health test of the host system according to the validating programs corresponding to the assigned selectable commands.

Moreover, the claimed invention provides an Intelligence Platform Management Interface (IPMI) validating system used between a host system and an operation terminal. The IPMI validating system comprises a programming table for storing a predefined rule defining a plurality of validating programs corresponding to a plurality of text strings, a user interface configured in the operation terminal, for editing a test text file based on the predefined rule, a translating unit for translating the test text file into validating programs, and a validating module, disposed at the host system, for performing a health test of the host system according to the translated validating programs.

Additionally, the claimed invention provides a method of simplifying a validating system for the Intelligent Platform Management Interface (IPMI) used between a host system having an IPMI, and an operation terminal. The method comprises the steps of editing a test text file based on a predefined rule which defines a plurality of validating programs corresponding to a plurality of text strings,

translating the test text file into validating programs, and performing a health test of the host system according to the translated validating programs.

Additionally, the claimed invention provides a method of simplifying a validating system for the Intelligent Platform Management Interface (IPMI) used between a host system having an IPMI, and an operation terminal. The method comprises the steps of providing a plurality of selectable commands, wherein each of the selectable commands corresponds to a validating program stored in a validating program library, assigning one or more of the selectable commands, translating the assigned validating programs into a test text file, editing the test text file based on a predefined rule which defines a plurality of validating programs corresponding to a plurality of text strings, translating the edited test text file into validating programs, and executing a health test of the host system according to the assigned validating programs.

The disclosed inventions will be described with reference to the accompanying drawings, which show important sample embodiments of the invention and which are incorporated in the specification hereof by reference.

### BRIEF DESCRIPTION OF THE DRAWINGS

FIG. 1 shows an ICTS flowchart and structure known in the prior art.

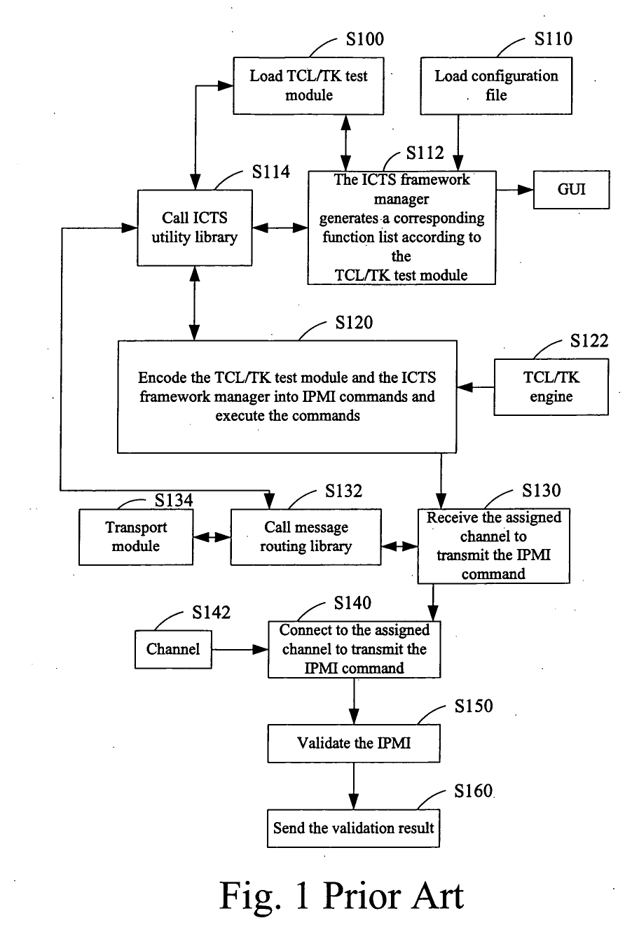

FIG. 2 is a system diagram of an IPMI validating system in accordance with the present invention.

FIG. 3 is a system diagram of a first embodiment of the IPMI command engine module and GUI depicted in FIG. 2.

FIG. 4 is an example of a test text file according to the preset invention

FIG. 5 is a system diagram of a second embodiment of the IPMI command engine module and GUI depicted in FIG. 2.

FIG. 6 is a flowchart of the method of validating an IPMI system in accordance with the present invention.

### DETAILED DESCRIPTION OF THE PREFERRED EMBODIMENT

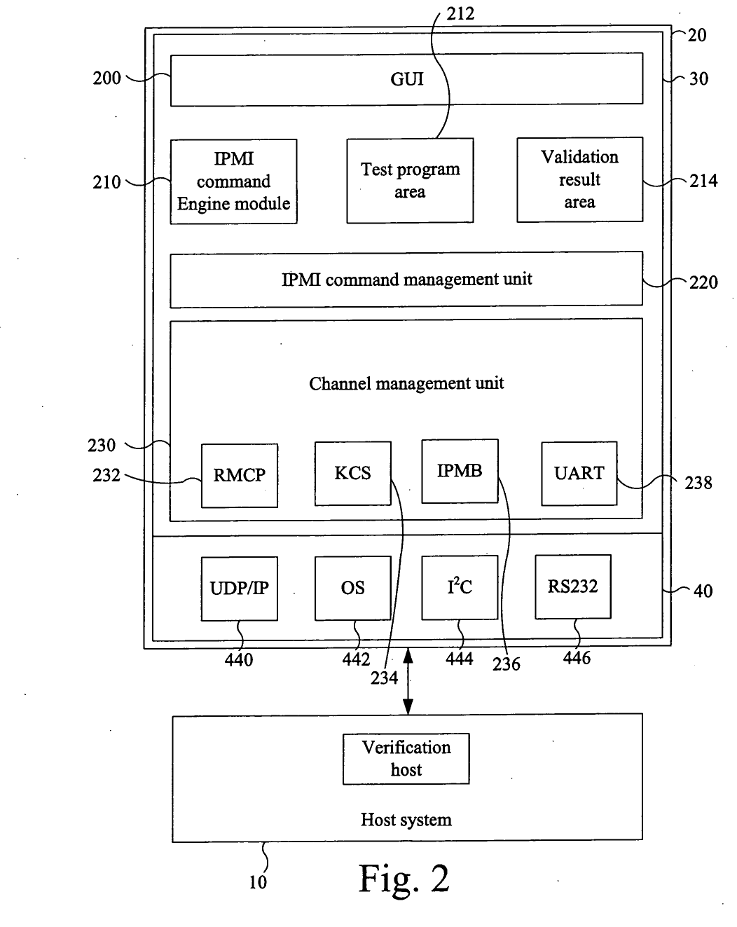

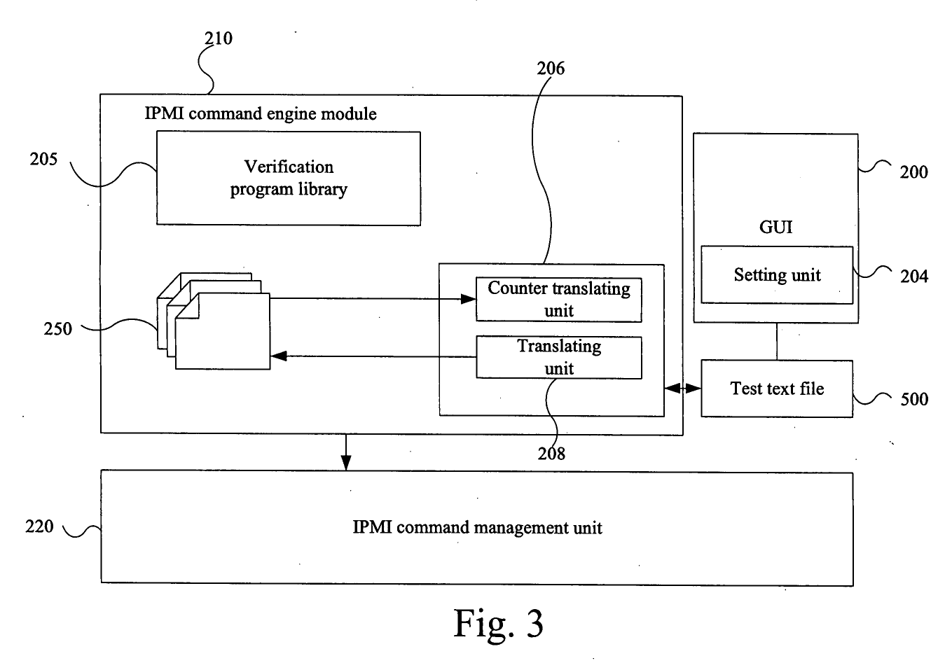

Please refer to FIG. 2 and FIG. 3. FIG. 2 is a system diagram of an IPMI validating system in accordance with the present invention. FIG. 3 is a functional block diagram of a first embodiment of the IPMI command engine module depicted in FIG. 2. The IPMI validating system 30 is optimally used between a host system 10 having an IPMI configuration and an operation terminal 20. The operation terminal 20 is a remote or near computer and is electrically connected to the host system 10 through a network system, such as LAN, or a connection, such as an RS-232 port. A transport interface layer 40 is formed at the operation terminal 20 and includes several kinds of interfaces, such as a UDP/IP protocol interface 440 and an RS-232 protocol interface 446, or driver software interfaces, such as an OS program interface 442 and an I²C driver software interface 444. All of these interfaces may communicate with the IPMI validating system 30 in accordance with the present invention via a channel for transmitting IPMI messages therebetween. The IPMI validating system 30 includes a graphical user interface (GUI) 200, an IPMI command engine module 210, an IPMI command management unit 220 and a channel management unit 230. The GUI 200 generates an output frame having a plurality of commands with optional items via the operation terminal 20. One of the commands includes an open mode item for allowing the user to load a predefined verification program and then modify it at any time for broadening the scope of the test, and at least one optional mode item to facilitate loading a default verification program as verifying code for immediate and fast validating of the IPMI.

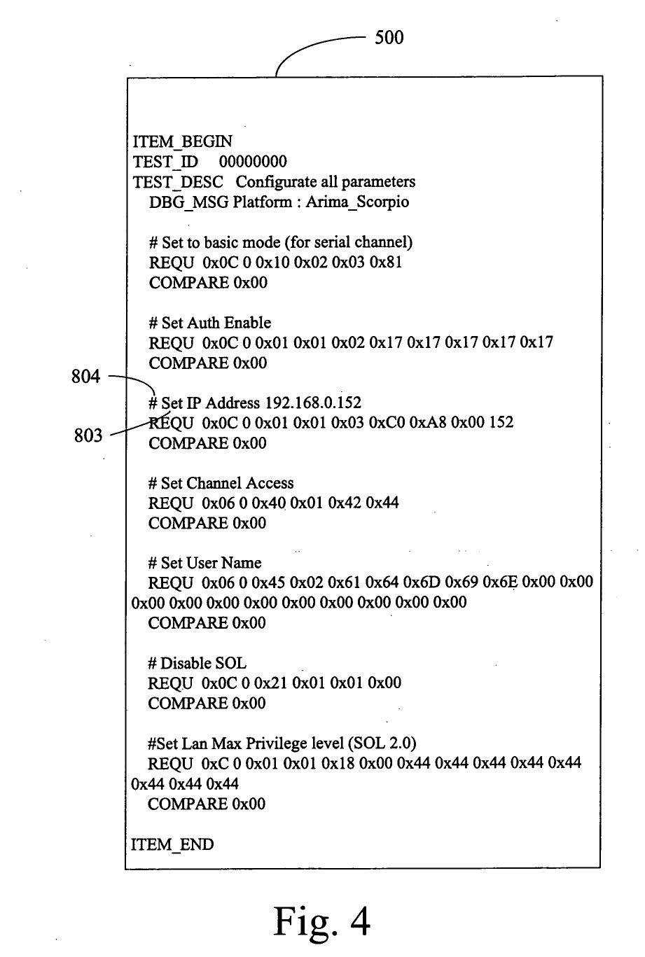

Please refer FIG. 4 in conjunction with FIG. 3. FIG. 4 shows an example of a test text file 500 according to the preset invention. When the GUI 200 is enabled and the open mode item is selected, multiple items, for example, labeled “system event log (SEL) test”, “watchdog test”, “sensor data record (SDR) test”, “chassis test” and “field replaceable unit (FRU) test”, are displayed. Each item corresponds to a validating program. The validating programs are programmed in TCL/TK language. If the “system event log (SEL) test” item is selected by using suitable pointer device such as a mouse and a keyboard, a pre-coded system event log (SEL) verification program stored in the validating program library 205 is accessed and delivered to the test program area 212. Next, the system event log verification program is translated as a text message 803 on a test text file 500 by the translating unit 208, as shown in FIG. 3. Similarly, if the other items are selected, the corresponding validating programs are accessed and delivered to the test program area 212 and translated as other text messages on the test text file 500. In addition, the setting unit 204 of the GUI 200 provides multiple selections to revise the test text file 500 so as to determine the performing parameters relating to when to perform the test for the host system or how many times to perform the tests. For example, the operator can set the system event log (SEL) verification program to be performed every 30 minutes. Next, the revised test text file 500 is translated as a plurality of validating programs 250 in sequence by the counter translating unit 206. Next, the validating programs 250 are transferred to the IPMI command management unit 220. Because all the selected validating programs 250 and the revised relative performing parameters are translated as shown in the test text file 500, the human operator who is unfamiliar with TCL/TK programming language can easily understand and arrange the test for the host system 10. Preferably, an identifying sign 804 (i.e. the term “#” shown in FIG. 4) is placed prior to such text message 803 as terms “Set IP Address 192.168.0.152 and “Set Channel Access”, translated from the validating program in that the human operator is liable to read and distinguish which text message 803 belongs to a validating program script. In other aspect, while the identifying sign 804 is matched, the counter translating unit 206 is capable of promptly translating the text message subsequent to the identifying sign into a required validating program.

Moreover, the GUI 200 can provide at least one channel item for the user to assign. For instance, a frame having items of “KCS”, “LAN”, “IPMB” and “Serial/Basic” is generated in the GUI 200, which gives access to KCS, RMCP, IPMB and UART channels shown in FIG. 2.

Note that instead of the TCL/TK script language used in the prior art, the present invention uses a new script language with simplified instruction set which is easier for beginners. It is convenient for the operator to use simplified commands to write any verification program at the windowed frame of the GUI 200.

In brief, The IPMI command engine module 210 is a script language translator for the simplified instruction set and directly encodes the loaded validating programs into an IPMI command and executes the IPMI command. Such an IPMI command is a machine code.

Next, the IPMI command is received by the IPMI command management unit 220 and transmitted to a channel assigned by the user. For instance, the user selects a “LAN” item in advance.

The channel management unit 230 is located at a protocol layer having a plurality of channel protocol conversion elements, such as a remote management control protocol (RMCP) element 232, an intelligent platform management bus (IPMB) protocol element 236, a keyboard control style interface (KCS) protocol element 234, and a universal asynchronous receiver/transmitter (UART) protocol element 238. Each protocol element can substantially correspond to one of the corresponding channel items appearing in the commands. For examples, the “LAN” item corresponds to the RMCP element 232; the “IPMB” item corresponds to the IPMB protocol element 236; the “KCS” item corresponds to the KCS protocol element 234; and the “Serial/Basic” item corresponds to the UART protocol element 238. Therefore, each of the channel protocol conversion elements of the channel management unit 230 would transform the IPMI command into a corresponding message conforming to the assigned channel protocol, such as RMCP protocol 232, according to the assigned channel item, such as the “LAN” item. Then the message is transmitted from the transport layer 40, such as UDP/IP 440, to the IPMI of the host system 10 for validation. In addition, the IPMI will send a validation result back along the same channel protocol, such as RMCP 232. The validation result is presented via the GUI 200 for the user to browse or save in a validation result area 214.

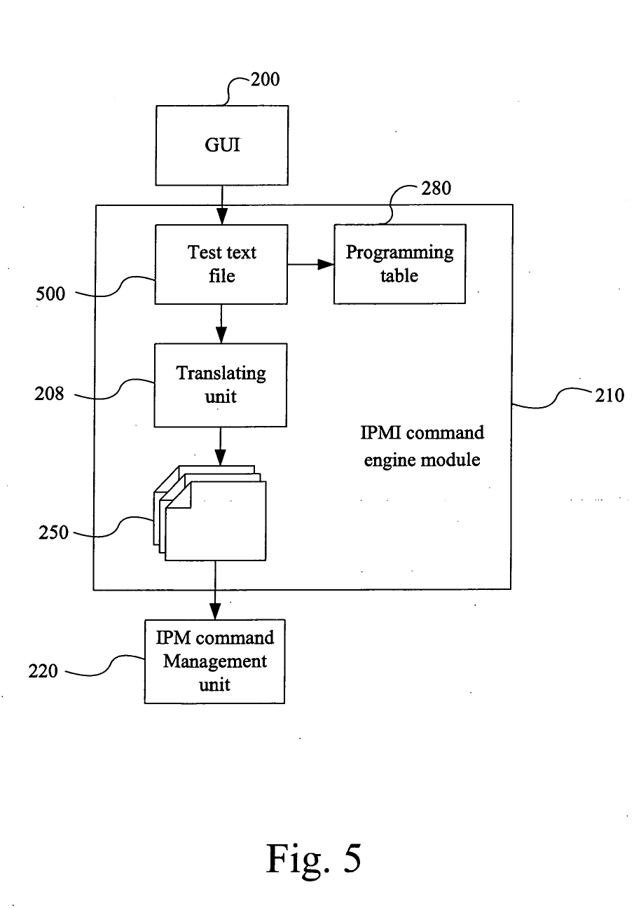

Referring to FIG. 5, a system diagram of the second embodiment of the IPMI command engine module 212 and GUI 200 depicted in FIG. 2 is shown. The user interface 200 of the IPMI validating system 30 provides an editing window for editing a test text file 500. A programming table 280 stores a predefined rule defining a plurality of validating programs corresponding to a plurality of text strings. With GUI 200, the operator can edit multiple text strings as the test text file 500 shown in FIG. 5. Preferably, an identifying sign “#” is required to distinguish the text messages corresponding to the validating programs. The translating unit 208 can translate the test text file 500 into validating programs based on the predefined rule stored in the programming table 280. Finally, through the similar elements which have the same function illustrated in FIG. 2, a validating module 180, disposed at the host system, performs a health test of the host system according to the translated validating programs.

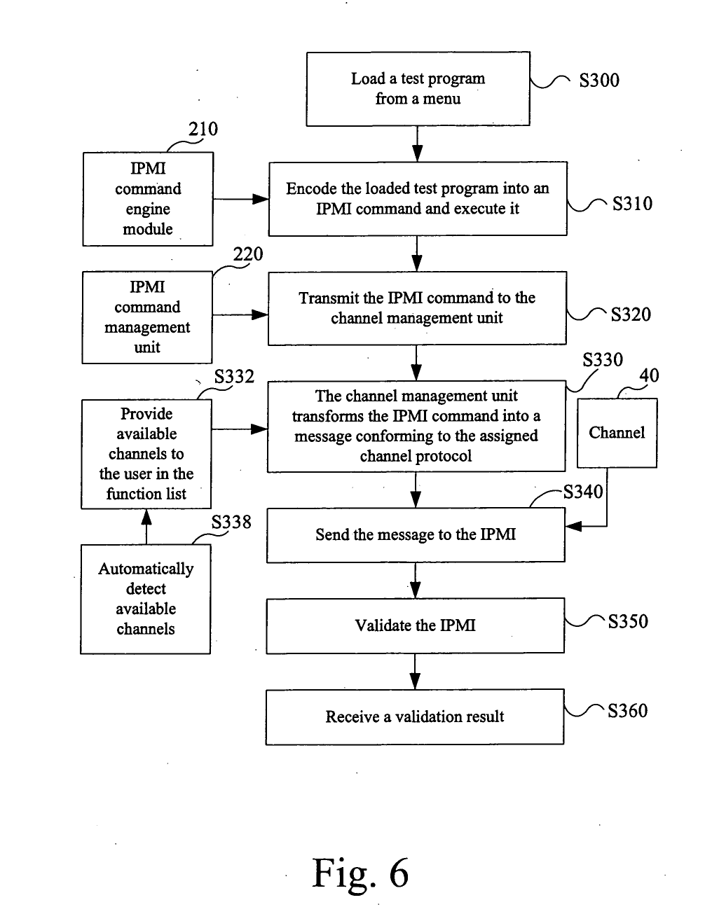

In addition, FIG. 6 is a flowchart of a method of validating an IPMI system in accordance with the present invention, which is optimally used between a host system having an IPMI and an operation terminal. The steps are as follows:

Step S300

The user can load a predefined test program for further modification or load a default test program to validate the IPMI at the GUI 200 of the operation terminal 20.

Step S310

The IPMI command engine module 210 directly encodes the loaded test program into an IPMI command and executes the IPMI command.

Step S320

Transmit the IPMI command to the channel management unit.

Steps S330, S332 and S338

The GUI 200 automatically provides the user with at least one available channel item to assign, such as a “LAN” item. Next, according to the assigned channel item “LAN”, the IPMI command is transformed into a message conforming to the assigned channel protocol such as RMCP 232, by the channel protocol conversion elements of the channel management unit 230.

Steps S340 and S350

The message is transmitted from the transport channel layer 40 of the operation terminal 20, such as UDP/IP 440, to the validating module 180 of the host system 10 through the assigned channel, such as the LAN channel, for validation.

Step S360

The IPMI sends a corresponding validation result back according to the same channel protocol RMCP 232. The validation result is received and then presented via the GUI 200 for the user to browse or save in a validation result area 214.

In contrast to the prior art, the IPMI validating system and method according to the present invention utilizes a new and simple management structure. The IPMI command engine module 210 can directly encode the validating program into an IPMI command. In addition, the present invention adopts a simple instruction set so that learning the script language and writing the verification program can be done quicker and easier. Therefore, the present invention is an improvement over the ICTS and the TCL/TK engine known in the prior art, which must be connected to different libraries, the transport modules and the configuration files, then combined with the ICTS framework management and the verification program to be transformed into the IPMI command. Thus, the validating system 30 of the present invention provides a higher performance efficiency and readability for IPMI thereby raising validating efficiency.

The present invention has been described with reference to certain preferred and alternative embodiments which are intended to be exemplary only and not limiting to the full scope of the present invention as set forth in the appended claims.

What is claimed is:

1. An Intelligent Platform Management Interface (IPMI) validating system used between a host system and an operation terminal, the IPMI validating system comprising:
a validating program library for storing a plurality of validating programs coded in a programming language;
a user interface configured in the operation terminal, for providing a plurality of selectable commands to be assigned wherein each of the selectable commands corresponds to one of the validating programs stored in the validating program library; and
a validating module disposed at the host system, for executing a health test of the host system according to the validating programs corresponding to the assigned selectable commands.

2. The Intelligence Platform Management Interface validating system of claim 1, wherein the programming language is TCL/TK language.

3. The Intelligence Platform Management Interface validating system of claim 1, further comprising:
a translating unit for translating the validating programs into a test text file;
a setting unit for editing the test text file; and
a counter-translating unit for translating the edited test text file into validating programs and transferring the validating programs to the validating module.

4. The Intelligence Platform Management Interface validating system of claim 3, wherein the test text file includes an identifying sign to identify the command corresponding to the validating program.

5. The Intelligence Platform Management Interface validating system of claim 1, wherein the validating program is selected from a group consisting of a system event log (SEL) test program, a watchdog verification program, a sensor data record (SDR) verification program, a chassis verification program and a field replaceable unit (FRU) verification program.

6. An Intelligence Platform Management Interface (IPMI) validating system used between a host system and an operation terminal, the IPMI validating system comprising:
a programming table for storing a predefined rule defining a plurality of validating programs corresponding to a plurality of text strings;
a user interface configured in the operation terminal, for editing a test text file based on the predefined rule;
a translating unit for translating the test text file into validating programs; and
a validating module, disposed at the host system, for performing a health test of the host system according to the translated validating programs.

7. The Intelligence Platform Management Interface validating system of claim 6, wherein the validating programs are programmed in TCL/TK language.

8. The Intelligence Platform Management Interface validating system of claim 6, wherein the test text file includes an identifying sign to identify the text string corresponding to the validating program.

9. The Intelligence Platform Management Interface validating system of claim 6, wherein the validating program is selected from a group consisting of a system event log (SEL) verification program, a watchdog verification program, a sensor data record (SDR) verification program, a chassis verification program and a field replaceable unit (FRU) verification program.

10. A method of validating an Intelligent Platform Management Interface (IPMI) of a host system, the method comprises the steps of:
(a) editing a test text file based on a predefined rule which defines a plurality of validating programs corresponding to a plurality of text strings;
(b) translating the test text file into validating programs; and
(c) performing a health test of the host system according to the translated validating programs.

11. The method of claim 10, wherein the validating programs are programmed in TCL/TK language.

12. The method of claim 10, wherein the step (a) further comprises adding an identifying sign to identify the text string corresponding to the validating programs.

13. The method of claim 10, wherein the validating programs are selected from a group consisting of a system event log (SEL) verification program, a watchdog verification program, a sensor data record (SDR) verification program, a chassis verification program and a field replaceable unit (FRU) verification program.

14. The method of claim 10, further comprising:
storing a result of the health test of the host system according to the translated validating programs

15. A method of validating an Intelligent Platform Management Interface (IPMI) of a host system, the method comprises the steps of:
(a) providing a plurality of selectable commands, wherein each of the selectable commands corresponds to a validating program stored in a validating program library;
(b) assigning one or more of the selectable commands;
(c) translating the assigned validating programs into a test text file;
(d) editing the test text file based on a predefined rule which defmes a plurality of validating programs corresponding to a plurality of text strings;
(e) translating the edited test text file into validating programs; and
(f) executing a health test of the host system according to the assigned validating programs.

16. The method of claim 15, wherein the validating programs are programmed in TCL/TK language.

17. The method of claim 15, wherein the step (d) further comprises adding an identifying sign to identify the text string corresponding to the validating program.

18. The method of claim 15, wherein the validating programs are selected from a group consisting of a system event log (SEL) verification program, a watchdog verification program, a sensor data record (SDR) verification program, a chassis verification program and a field replaceable unit (FRU) verification program.
